(19) United States
(12) Patent Application Publication
(10) Pub. No.: US 2006/0126103 A1
(43) Pub. Date: Jun. 15, 2006

(54) Post-operative polling for adjusting document processing settings

(75) Inventors: Mark J. Edwards, Lexington, KY (US); John T. Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/007,981

(22) Filed: Dec. 9, 2004

(51) Int. Cl. G06F 3/12

(52) U.S. Cl. 358/1.15

(57) ABSTRACT

A method for modifying settings for document jobs in a document processing device, a document processing device for performing the same and a system comprised of a document processing device and computer workstation for performing the same. The method can include processing a document job according to one or more settings to produce output, polling a user for a setting modification after processing the document job, receiving a user-selected setting modification, determining if modification of the one or more settings is to be made based on the selected setting modification, and processing at least one subsequent job according to the modified settings determined to require modification.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

Embodiments of the invention relate, in general, to methods and systems of using document processing devices and, in particular, to method and systems of polling a user after processing a document to adjust document processing settings based on the user's answers.

Typically, users of document processing devices, such as printers, scanners, copiers, facsimile machines, and devices that provide a combination of features, do not adjust document processing settings. Generally, users operate the devices at default settings. Although some users can find the default settings acceptable, others do not. Some document processing devices attempt to “intelligently guess” settings to produce adequate output. “Intelligent guesses,” however, often do not account for user preferences such as processing speed and quality. For example, a user preferring a quick draft of a document containing images can receive a high-resolution and slowly-printed document from a printer that is configured to “intelligently guess” that documents containing images should be printed at a high resolution and, consequently, a low speed.

### SUMMARY OF THE INVENTION

Embodiments of the invention provide a method for modifying settings for document jobs. The method can include processing a document job according to one or more settings to produce output, polling a user for selecting a setting modification after processing the document job, receiving the user-selected setting modification, determining if modification of one or more settings is to be made based on the selected setting modification, and processing at least one subsequent document job according to the modified settings determined to require modification.

Additional embodiments can provide a document processing device comprising a processor, a memory, a user interface and a communication link between the foregoing elements. The document processing device can be configured to process a document job according to one or more settings to produce output, after processing the document job generate on the user interface a user poll containing a plurality of setting modification choices for selection by a user, accept a user-selected setting modification, determine if modification of the one or more settings is to be made based on the selected setting modification, and process at least one subsequent document job according to the modified settings determined to require modification.

Another embodiment provides a computer-readable medium that includes instructions for modifying document processing settings. The computer-readable medium can include instructions for processing a document job according to one or more settings to produce output, generating a user poll containing a plurality of setting modifications after processing the document job, receiving a user-selected setting modification, determining if modifications to the one or more settings are to be made based on the selected setting modification, and processing at least one subsequent document job according to the modified settings determined to require modification.

Yet another embodiment provides a method of determining settings for a document processing device. The method can include obtaining a first document job, the first document job including a first parameter, processing the first document job according to one or more settings to produce output, polling a user for a setting modification after processing the first document job, receiving the user-selected setting modification, storing the first parameter and the selected setting modification, obtaining a second document job, the second document job including a second parameter, and determining one or more settings for the second document job based on the selected setting modification.

Another embodiment provides a document processing device comprising a processor, a memory, a user interface and a communication link between the foregoing elements. The device can be configured to obtain a first document job including a first parameter, process the first document job according to one or more settings to produce output; after processing the first document job, generate on said user interface a user poll having a plurality of settings modifications for selection by a user after processing the first document; receive via said user interface said selected setting modification, store the first parameter and the setting modification, obtain a second document job including a second parameter, and determine one or more settings for the second document job based on the selected setting modification.

Additional embodiments provide a computer-readable medium including instructions for determining document processing settings. The computer-readable medium can include instructions for obtaining a first document job, the first document job including a first parameter, processing the first document job according to one or more settings to produce output, generating and displaying a user poll after processing the first document job, receiving a user selected setting modification, storing the first parameter and the selected setting modification, obtaining a second document job, the second document job including a second parameter, and determining if modification to the one or more settings for the second document job are to be made based on the selected setting modification.

Another embodiment provides a system for modifying document processing settings. The system can include a document processing device having a processor, a memory, and a communication link between the foregoing elements with the processor configured to obtain a first document job including a first parameter, and to process the first document job according to one or more settings to produce output and a workstation in communication with the document processing device with said workstation configured to generate a user poll having a plurality of setting modifications for selection by a user after the document processing device processes the first document job and to receive the user-selected setting modification.

Yet another embodiment provides a method of adjusting one or more settings for a document processing device. The method can include processing at least one document job according to one or more settings to produce output, and polling a user for a setting modification after processing the document job at a predetermined frequency.

Other features and advantages of embodiments of the invention will become apparent to those skilled in the art upon review of the following detailed description and drawings.

### BRIEF DESCRIPTION OF THE DRAWINGS

In the drawings:

FIG. 1 illustrates an exemplary document processing system including a workstation and a document processing device.

FIG. 2 illustrates an exemplary operator panel that is suitable for use in the document processing device of FIG. 1.

FIG. 3 is a schematic diagram of hardware inside the document processing device of FIG. 1.

FIG. 4 is a schematic diagram illustrating software that can be stored in the memory illustrated in FIG. 3.

FIG. 5 is a schematic diagram of non-volatile memory, which can be part of the memory illustrated in FIG. 4.

FIG. 6 is a flow chart illustrating an exemplary process of adjusting document processing settings.

FIG. 7 is a screen shot of an exemplary post-operative poll dialog window.

FIG. 8 is a schematic diagram of an exemplary learning process performed by the processing device of FIG. 1.

FIG. 9 is a screen shot of another exemplary post-operative poll.

FIG. 10 is schematic diagram of non-volatile memory, which can be part of the memory illustrated in FIG. 4.

FIG. 11 is a schematic diagram of an exemplary dynamic setting determination performed by the processing device of FIG. 1.

FIG. 12 illustrates the document processing system of FIG. 1 including a card reader and a user card.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

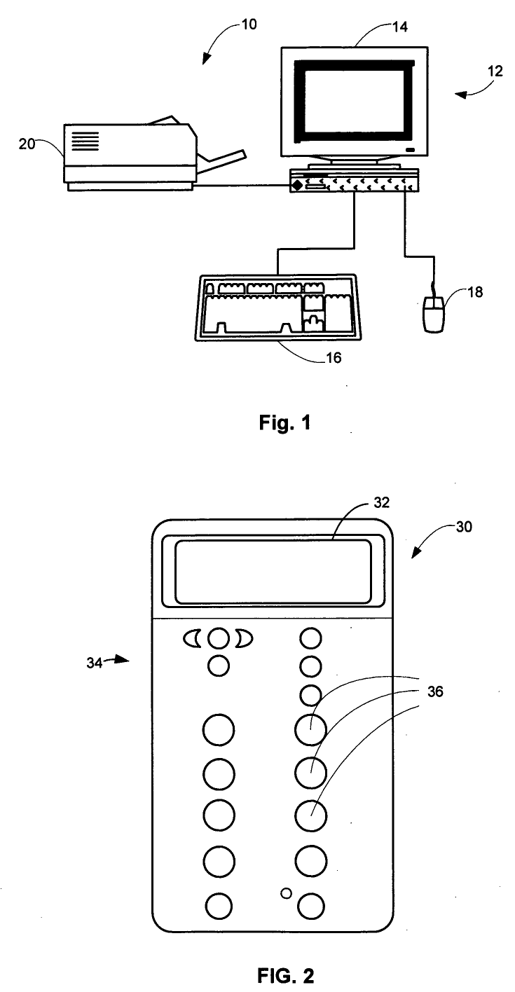

FIG. 1 illustrates an exemplary document processing system 10. The system 10 includes a workstation 12 having a monitor or display 14, a keyboard 16, and a cursor control device 18, which is shown in the form of a mouse. The workstation 12 is connected to a document processing device 20. The device 20 can provide printing, scanning, faxing, copying, or a combination thereof. In addition, although the device 20 is shown as a peripheral connected to the workstation 12, the device 20 can also operate as a stand-alone device. For example, using scanning and printing functionality provided by the device 20, a user could scan a document and print one or more copies of the scanned document without requiring interaction with the workstation 12. As should also be apparent, the system 10 can also be configured to include multiple workstations, document processing devices, and other devices not shown. Routers, switches, or network connections allowing the components and devices of the system 10 to communicate can also be included. In addition, the various connections between elements of the system 10 can include both wired and wireless connections as well as local area network and wide area network connections.

FIG. 2 illustrates an exemplary interface or operator panel 30 of the device 20. The operator panel 30 includes a graphical display 32 and a keypad 34 having a variety of input buttons 36. A user can use the keypad 34 and the input buttons 36 to modify document processing settings. In some embodiments, the graphical display 32 includes a touch screen that a user can use to modify document processing settings. It should be apparent that the operator panel 30 may include other input mechanisms such as a keyboard or a cursor control device, such as a mouse, joystick, trackball, and the like. The operator panel 30 may also include a speaker (not shown) and/or a microphone to communicate with another device of the system 10 or a user through audio signals.

When the device 20 is connected to the workstation 12, a user can also modify document processing settings via the workstation 12. In some embodiments, the display 14 of the workstation 12 displays a document processing setting menu or poll containing a plurality of setting modifications to a user and the user uses the keyboard 16 and/or cursor control device 18 to modify document processing settings. The workstation 12 can also include additional input and output devices, such as a touch screen, a joystick, a speaker, a microphone, and the like, that a user can use to modify document processing settings.

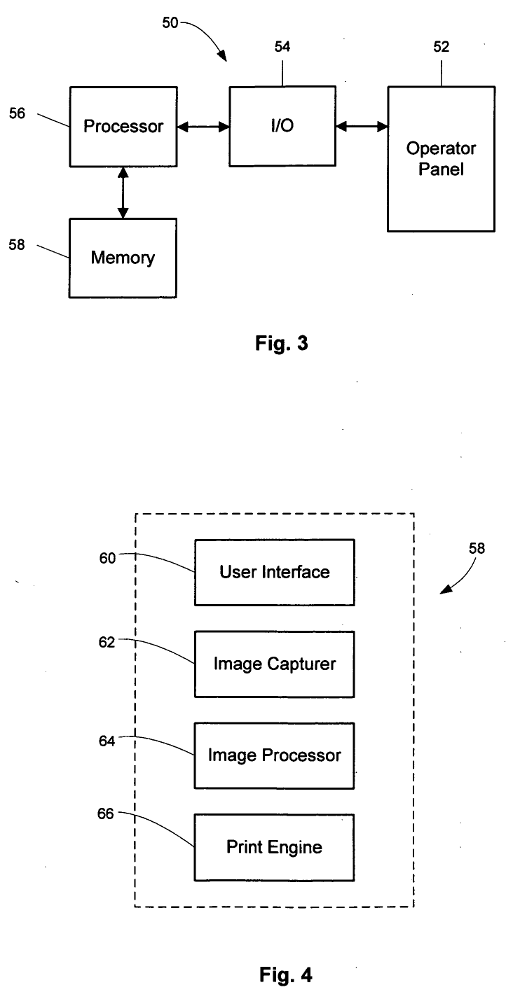

FIG. 3 illustrates hardware 50 that can be used in the device 20. In the exemplary configuration shown, the hardware 50 includes an operator panel module 52, an I/O module 54 or communication link, a processor 56, and a memory module 58. In some embodiments, the operator panel module 52 includes hardware and/or software that comprises and/or controls the operator panel 30. The I/O module 54 can provide hardware and/or software to communicate with a connected device, such as the workstation 12. The memory module 58 can contain non-volatile memory such as one or more forms of ROM, one or more disk drives, RAM, other memory, or combinations of the foregoing.

FIG. 4 illustrates the possible contents of the memory module 58 or a portion thereof. As illustrated in FIG. 4, the memory module 58 contains software. The software is illustrated as having four portions: a user interface 60, an image capturer 62, an image processor 64, and a print engine 66. In various implementations, the software can be configured in such a way that it does not include four distinct portions. Functional features of the software and data stored in the memory module 58 can be combined in a variety of ways. In some embodiments, the user interface 60 includes instructions for generating output and accepting input from the operator panel 30, and the image capturer 62 includes instructions for capturing data from a capture device such as an array of charge-coupled devices (“CCD”) or a CIS scanbar in a scanner or the like. The image processor 64 can include instructions for processing image data such as increasing or decreasing the displayed size of an image, increasing or decreasing brightness or contrast, adjusting color balance, etc., and the print engine 66 can include instructions for converting data into a format that is suitable for use by a printer. It should be apparent that the memory module 58 is not limited to the components listed and can contain other applications and data used to support the device 20. Software used in devices to carry out basic operations such as scanning, printing, and faxing is well known and, therefore, not described.

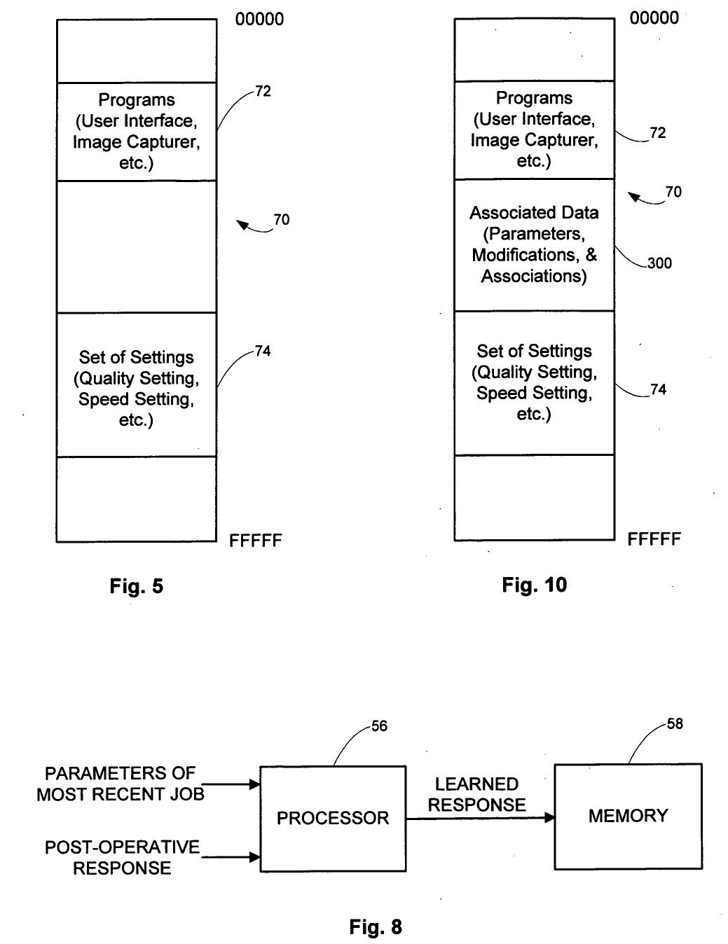

FIG. 5 is an exemplary diagram of a non-volatile memory portion 70 of the memory module 58. The memory portion 70 contains a program section 72 and a settings section 74. The program section 72 can hold application programs such as the user interface 60, the image capturer 62, the image processor 64, and the print engine 66, and the settings section 74 can include one or more settings that specify how the device 20 should process document information. In some embodiments, the device 20 stores one or more settings for each type of operation the device 20 is capable of performing. For example, the settings section 74 can include a group or table of settings that the device 20 uses when printing a document, another group of settings that the device 20 uses for scanning a document, and another group of settings the device 20 uses for copying a document. The group of settings used by the device 20 can depend on the type of operation requested of the device 20.

The settings can include a quality setting with values such as “DRAFT,” “NORMAL,” and “BETTER” or “HIGH RESOLUTION.” The quality setting can also designate a speed setting. The quality setting and speed setting can be linked such that an increase in one setting causes a decrease in the other setting. For example, processing a. document using a “BETTER” or “HIGH RESOLUTION” quality setting can require more time than processing a document using a “DRAFT” quality setting. Generally, higher quality increases the resolution of the output and the time that is required to generate such output. The settings section 74 can also include one or more default settings. The device 20 can be initialized to these settings when it is manufactured.

The settings section 74 can also include other settings, such as a color/black-and-white setting, a lightness/darkness setting, a number-of-outputs setting, a magnification setting, an output-media setting, a one-sided/double-sided setting, a collate setting, a staple setting, and the like.

In some embodiments, the settings section 74 can include one or more modes where each mode specifies values for one or more settings. When the device 20 processes a document, rather than determining or selecting a value for multiple settings the device 20 may select a mode stored in the settings section and process the document according to the settings specified in the selected mode. For example, the settings section 74 can include a range of modes such as “DRAFT,” “NORMAL,” “BETTER,” and “BEST” that specify setting values for generating draft quality output to high resolution quality output.

It should be apparent that the memory module 58 can also contain more or less designated sections and can contain designated sections that contain different types of data or software than those illustrated in FIG. 5.

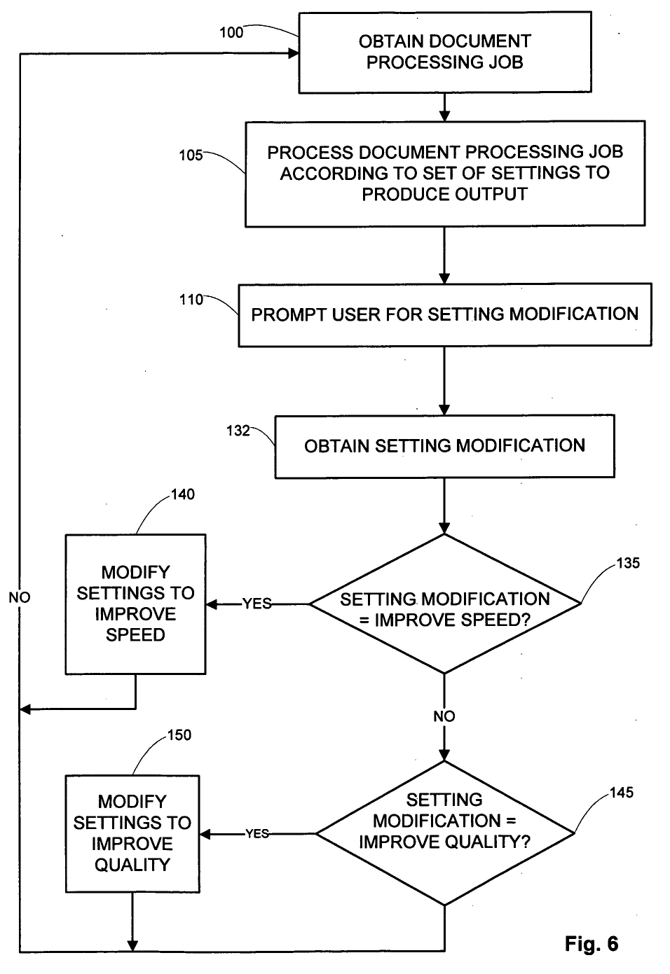

FIG. 6 is a flow chart describing an exemplary process of setting or adjusting document processing settings using post-operative polling. The process steps illustrated in FIG. 6 are exemplary in order and content, and the document processing setting process can be accomplished with a subset of the depicted steps or additional and alternative steps. It should also be understood that the process depicted in FIG. 6 can be executed by the device 20, one or more workstations 12, or a combination of the device 20 and a connected workstation 12.

The process begins at step 100 where the device 20 obtains a document job, which requests processing of a document. The document job can include a document to be processed and one or more parameters. The one or more parameters can specify an application executing on the workstation 12 that submitted the job, a user who submitted the job, a document type (e.g., a text-base document or an image-based document) or particular document of the document set included in the document job, processing parameters for the document job such as a media type, a magnification level for the job, number of pages of the document, and number of copies of the document, and the like.

After receiving the document job, the device 20 processes the job according to one or more settings to produce output (step 105). The settings used or applied by the device 20 can be saved in the setting section 74 of the memory module 58 as previously described. The settings used by the device 20 can include default settings of the device 20 or can also include settings set by a user before submitting or initiating a document job. The produced output can include a printed hardcopy of a document, an image of a scanned document, or the like.

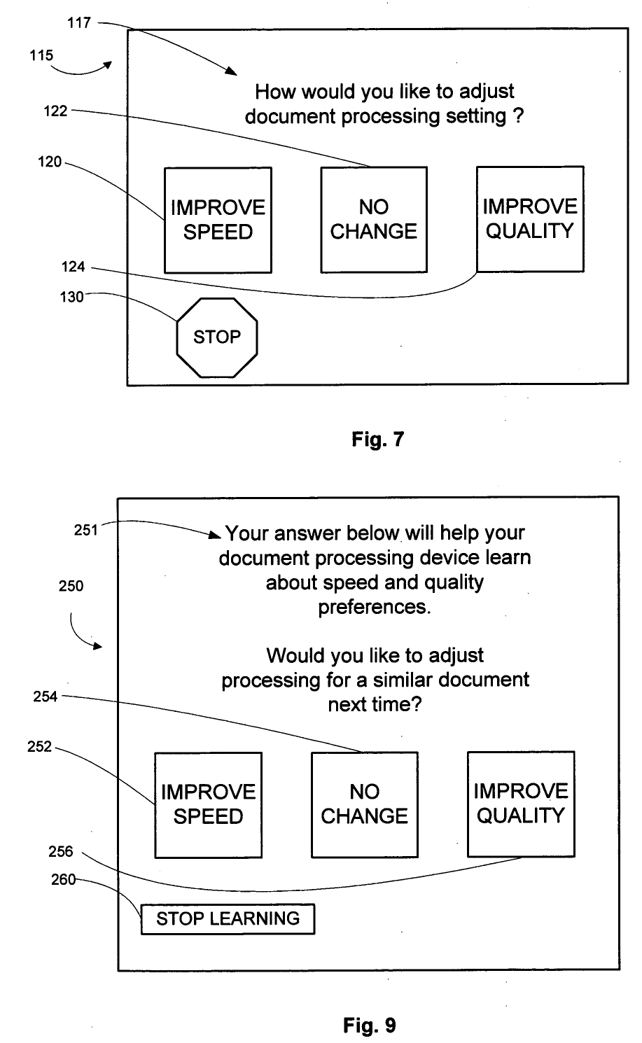

After the device 20 processes the document job and produces output, the device 20 polls or prompts a user about what changes (if any) the user would like to see to future document jobs based on the output recently produced (step 110). A user can be polled on the display 14 of the workstation 12 when the device is connected to the workstation. A user can also be polled on the graphical display 32 of the operator panel 30. A user can also be polled audibly by the device 20 and/or the workstation 12. The device 20 can also generate a hardcopy poll by printing a prompt that includes instructions for a user on how to modify document processing settings manually. FIG. 7 illustrates an exemplary post-operative poll dialog window 115 that can be displayed to a user. In some embodiments, the post-operative poll 115 includes a textual or visual prompt 117 that poses the question “HOW WOULD YOU LIKE TO ADJUST DOCUMENT PROCESSING SETTINGS?” to a user. The poll 115 receives a user-selected setting modification by allowing a user to choose from three options including an improve speed selection 120, a no change selection 122, and an improve quality selection 124. The poll 115 can also include a stop selection 130 that a user can use to stop or turn off the post-operative polling and the display of the poll 115. The poll 115 can also time out if the user does not respond, which has the same result as selecting the no change selection 122.

It should be apparent that other modifications can be included on the poll 115. For example, the poll 115 can include a selection to adjust printing on one or two sides of a sheet of paper (such as a double-sided selection and a single-sided selection), a color selection, a black-and-white selection, a lighten selection, a darken selection, an increase-magnification selection, and/or a decrease-magnification selection. In some embodiments, the prompt 115 can list settings and allow a user to manually set a value for each setting. The poll 115 can restrict a user from setting conflicting setting values or setting values that cannot be provided by the device 20. In some embodiments, the prompt 115 can list settings and allow a user to adjust a setting through a range of acceptable setting values to provide a simple user interface and further restrict a user from setting conflicting or unattainable setting values. In some embodiments, the prompt 115 can display trade-off settings (i.e., speed versus quality, light versus dark, etc.) where an improvement or increase to one setting usually results in a downgrade or decrease in the other setting. When displaying trade-off settings, the prompt 115 can restrict a user from selecting both trade-off settings and can provide a simple user interface that poses one or more binary questions (e.g., a “YES/NO” question, an “INCREASE/DECREASE” question, and the like) to a user rather than posing multiple settings each with multiple setting values.

Referring back to FIG. 6, once the user is prompted to select from a plurality of setting modifications, the device 20 obtains a setting modification from a user via the poll 115 (step 132). At step 135, the device 20 determines if the user has selected the improve speed selection 120. If a user has selected the improve speed selection 120, the device 20 modifies the settings to improve the processing speed (step 140). Modifying the settings can include changing the value of one or more settings and saving the changes as the new default settings. Modifying the settings can also include selecting a mode, as described above, to be used by the device 20 for future document jobs. For example, if a user selects the improve speed selection 120 after the device 20 processes a job using a “BETTER” mode, the device 20 can use a “NORMAL” or default mode for subsequent jobs. Modifying the settings can also include retaining the settings at their current values. If, for example, the current settings are already set to provide the highest speed capable by the device 20 and the user selects the improve speed selection 120, no changes are made to the settings. In addition, the device 20 can notify the user, visually or audibly or both, that no changes are possible.

As previously described, in some embodiments, a user can only be allowed to select one setting modification. For example after selecting the improve speed selection 120 and modifying the settings, the device 20 can wait to obtain a subsequent document job which starts the process again at step 100.

Alternatively, if at step 135 the device 20 determines that a user has not selected the improve speed selection 120, the device 20 determines if a user has selected the improve quality selection 124 (step 145). If a user has selected the improve quality selection 126, the device 20 modifies the settings to improve processing quality at step 150. As previously noted, modifying the settings can include modifying the values of individual settings to create new default settings for the device 20 or modifying the default mode of the device 20.

After modifying the settings to increase quality, the device 20 waits for a subsequent document job at step 100. Each new job is processed according to the modified settings.

If a user did not select the improve speed selection 120 or the improve quality selection 126, or if the polling period has timed out, it is assumed that the user selected the no change selection 122 and no modifications are made to the settings. The device 20 returns to step 100 to await another document job.

The frequency of post-operative polling can be set to a predetermined frequency. In some embodiments, the user can be polled after every operation of the device 20 or until a user selects the stop selection 130. Alternatively, a user can be polled only after a predetermined number of operations such as the first few operations (e.g., the first five prints, first five scans, first five copies, etc.). A user can also be polled (once or a few times) whenever a new operation scenario is detected, such as printing from a new application executing on the workstation 12, scanning a new type of document, or printing on a new type of print media. In addition, a user can also be polled when it appears that the user is not familiar with checking and/or adjusting document processing settings. For example, if a user checks and/or adjusts document processing settings before initiating a document job, the user will not be polled after the job is completed. Polling can also be skipped if an error occurs during processing of the job. It should be apparent that the frequency of polling a user after processing a document can be varied in numerous ways beyond those listed above.

In one embodiment, after a modification is made to the settings, the modification remains in effect for all further operations (i.e., all print jobs are affected by a print quality change, all scanning jobs are affected by a scan quality change, all copying jobs are affected by a copy quality change, etc.) until another modification is made. For example, if a document containing images is printed from a first application executing on the workstation 12 and the user selects to improve print quality, all further print operations, including a document containing only text printed from a second application different from the first application, prints at the improved print quality setting (unless changed by a user either manually before printing the document or during the post-operative polling). Applying a setting modification to all future jobs regardless of parameters of the job is effectively similar to changing the default settings of the device 20. Changing the default settings through post-operative polling (when a user has tangible output to base decisions on) helps reduce reliance on a user to know or estimate desired settings and set them using the operator panel 30 prior to executing a job. Using the post-operative polling, the device 20 can be shipped with default settings set to the lowest quality settings or the lowest speed quality settings and the user can adjust the settings to their preferences through post-operative polling as they use the device 20.

Alternatively, in another embodiment, a modification can be associated with one or more parameters of a document job and can be only applied to future document jobs that include parameters associated with the modification. For example, an improved quality setting can be generated after a user prints a document from a first application, which, for example, can be an image editing application, and the improved quality setting can only be applied to future jobs submitted from that application. A modification can also be associated with a particular document type (e.g., text-based document, image-based document, word-processing document, image-processing document, and the like) or even a particular document. Modifications can further be associated with one or more processing settings provided with the document job or provided at the document processing device such as a media type setting, magnification level setting, single-sided or double-sided setting, and the like.

In some embodiments, the device 20 “learns” setting modifications associated with parameters of document jobs through post-operative polling by implementing a type of artificial intelligence (“AI”). FIG. 8 schematically illustrates a “learning” process provided by the device 20. It should be understood that one or more workstations 12 connected to the device 20 can also perform the process illustrated in FIG. 8 and described below in addition to, in replace of, or in combination with the device 20.

As illustrated in FIG. 8, the device 20 obtains one or more parameters of the last or most recent job processed and a post-operative setting modification made by a user. In some embodiments, the post-operative setting modification can be obtained by the device 20 as described and illustrated above. In other embodiments, the poll provided to a user can include an indication of the learning process being performed by the device 20. FIG. 9 illustrates an exemplary post-operative poll 250 that can be displayed to a user during the learning process. Similar to the post-operative poll 115 illustrated in FIG. 7, the post-operative poll 250 includes three options including an improve speed selection 252, a no change selection 254, and an improve quality selection 256. In contrast to the post-operative poll 115, however, the post-operative poll 250 can include a visual or textual prompt 251 that informs a user of the learning process being performed by the device 20 such as “YOUR ANSWER BELOW WILL HELP THE DOCUMENT PROCESSING DEVICE LEARN ABOUT SPEED AND QUALITY PREFERENCES.” The prompt 251 can also pose the question “WOULD YOU LIKE TO ADJUST PROCESSING FOR A SIMILAR DOCUMENT NEXT TIME?” to a user to indicate that changes will be applied to similar jobs received in the future.

The post-operative poll 250 can further include a stop learning selection 260 that a user can use to terminate the learning process performed by the device 20. In some embodiments, selecting the stop learning selection 260 can stop or turn off the learning process but can continue post-operative polling and associated setting modifications as described above in FIG. 6. Selecting the stop learning selection 260 can also terminate all post-operative polling and related setting modifications.

After obtaining one or more post-operative user-selected modifications via the poll 250, the device 20 provides the one or more parameters and post-operative modifications to the processor 56 of the device 20 (or a separate AI module), which creates an association or link between the one or more parameters and selected modifications. In some embodiments, an association can include a pointer or handle to the one or more modifications held by the at least one of the one or more parameters or vice versa. Another type of association can include placing the one or more parameters and modifications as attributes of a common data object or structure. An association can also be a physical association by sequentially storing the one or more parameters and modifications in a memory module. Mechanisms other than those described above can also be used to relate the one or more parameters to the one or more modifications.

After creating an association between the one or more parameters and the one or more modifications, the processor 56 stores the one or more parameters and the associated modifications to the memory module 58 of the device 20. FIG. 10 illustrates an exemplary associated data section 300 of the memory module 58 where parameters, modifications, and corresponding associations are stored. In some embodiments, a separate memory module can be used to store the associated data. The modifications stored by the processor 56 can include the post-operative setting modification made by a user, the settings applied to the last job processed, and/or the settings as modified according to the post-operative decision.

In some embodiments, after storing the associated data, the device 20 can not adjust settings used by the device 20 as described above in FIG. 6, since the device 20 can dynamically determine settings to be used by the device 20 based on parameters of a future job and associations “learned” by the device 20. In other embodiments, the device 20 can adjust settings using the one or more post-operative modifications supplied by the user as described in FIG. 6 after storing the associated data. The device 20 can adjust settings based on the one or more post-operative modifications as a way to prepare for the next received job that can include similar parameters as the last processed job and, therefore, can use similar settings.

The learning process as described above can be repeated for any number of received document jobs. In some embodiments, upon receiving one or more post-operative modifications after processing a document job with one or more parameters similar or identical to parameters already stored to the associated data section 300, the device 20 can replace the previously stored modifications associated with the similar or matching parameters with the newly obtained modifications. The device 20 can also disregard subsequent modifications after an initial one or more modifications are associated with one or more parameters and stored in the memory module 58. The device 20 can also store multiple modifications or can store a single modification determined from multiple modifications with one or more parameters in the associated data section 300. In some embodiments, the device 20 can determine an average or other combination of multiple modifications associated with one or more parameters. For example, if one or more parameters are associated with a “BETTER” mode and a “DRAFT” mode, the device 20 can store a “NORMAL” mode with the parameters, which is between or the average of a “BETTER” mode and a “DRAFT” mode.

The device 20 can operate the learning process as described above for every submitted document job or periodically (e.g., every fifth submitted document job). In some embodiments, the device 20 can operate the learning process for a given amount of time or number of processed jobs. The device 20 can also operate the learning process continuously.

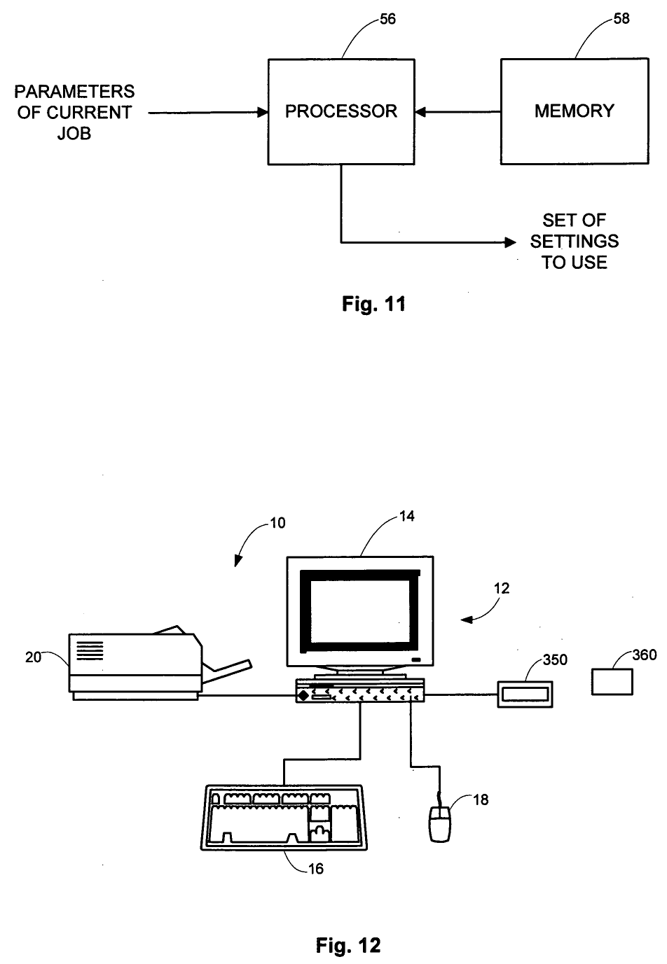

After the learning process is complete or concurrently during the learning process, the device 20 performs a dynamic setting determination process. As illustrated in FIG. 11, during the dynamic setting determination process, the device 20 obtains one or more parameters of a current document job. The one or more parameters are forwarded to the processor 56 of the device 20. The processor 56 accesses the memory module 58, or more particularly, the associated data section 300, and attempts to obtain one or more stored modifications that are associated with matching or similar stored parameters as those of the current job. In some embodiments, the processor 56 can obtain multiple modifications associated with parameters similar to the one or more parameters of the current job and the processor 56 can choose one modification from the multiple stored modifications. In some embodiments, the processor 56 can randomly choose one modification from a group of modifications or can select a modification from a group of modifications based on selection criteria such as the most recently stored modification, or the modification closest to the current settings used by the device 20. The processor 56 can also determine or calculate one modification from the multiple modifications. For example, as described above, the processor 56 can average or combine modifications to obtain a single modification. The device 20 can also provide a user with a list of obtained modifications and allow a user to select one of the modifications or override the suggested modification and manually specify the set of the settings for the device 20.

After obtaining a modification, the device 20 modifies the settings used by the device 20 based on the obtained modification. In some embodiments, the device 20 uses the obtained modification to determine initial settings and then applies a setting modification or adjustment as specified in a previous post-operative poll to create settings to be used to process the current job.

In some embodiments, there may not be a stored modification associated with one or more stored parameters that are similar to the one or more parameters of the current document job. In these situations, the device 20 can use default settings. The device 20 can also notify a user that settings could not be dynamically determined and can prompt a user to manually specify settings or accept default settings.

After determining the settings to use, the device 20 processes the job. After processing the job, the device 20 can perform the learning process or the. post-operative polling process without learning. Post-operative polling during the dynamic setting determination process is optional.

In some embodiments, the device 20 can retain the settings determined by the device 20 during the dynamic setting determination process after processing a job. The device 20 can also return to default settings after processing a job.

In some embodiments, the device 20 can determine additional parameters not initially provided with the document job to determine settings to use. For example, specific settings for scan and copy jobs can be tied to the type of document (e.g., text-based, image-based, etc.) being scanned and the device 20 can determine the type of document during a pre-scan.

Additional embodiments can also include associating document processing settings with users. In some embodiments, as previously noted, document jobs can include a user identification as a parameter. The device 20 may also read user identifiers from cards presented to the device 20. FIG. 12 illustrates the document processing system 10 with an external card reader 350 connected to the workstation 12. It should be understood that the card reader 350 may also be an internal or incorporated component of the device 20, the workstation 12, and/or one of the peripherals connected to the workstation 12 (e.g., the monitor 14, the keyboard 16, or the cursor control device 18). The card reader 350 can be configured to read a user card 360 presented by a user. The user card 360 can contain a user identifier that the card reader 350 can read and transmit to the device 20. The device 20 can use the user identifier read from the user card 360 to dynamically determine settings for a document job. The user card 360 can also store one or more sets of settings such that settings can be read by the card reader 350 and used by the device 20 to determine settings to use when processing a job.

Various features and advantages of the invention are set forth in the following claims.

1. In a document processing system, a method for modifying settings for document jobs comprising:
processing a document job according to one or more settings to produce output;
polling a user for selecting a setting modification after processing the document job;
receiving a user-selected setting modification;
determining if the modification to the settings are to be made based on the selected setting modification; and
processing a subsequent document job according to the modified setting determined to require modification.

2. The method as claimed in claim 1, wherein the setting modification includes an improve quality selection, an improve speed selection, and a no change selection.

3. The method as claimed in claim 2, wherein receiving the selected setting modification includes receiving at least one of the improve quality selection, the improve speed selection, and the no change selection.

4. The method as claimed in claim 1, wherein polling a user includes presenting a visual prompt to the user on one of an operator panel of a document processing device and a display of a workstation connected to the document processing device.

5. The method as claimed in claim 1, wherein polling a user includes presenting an audible prompt to the user.

6. The method as claimed in claim 1, wherein determining based on the selected setting modification includes selecting a mode.

7. The method as claimed in claim 1, wherein processing a subsequent document job includes adjusting at least one of a speed setting and a quality setting.

8. The method as claimed in claim 1, wherein processing a subsequent document job includes not adjusting the settings.

9. The method as claimed in claim 8, further comprising alerting the user that the one or more settings were not adjusted.

10. The method as claimed in claim 1, wherein polling a user includes presenting a stop selection.

11. A document processing device comprising:
a processor;
a memory;
a user interface; and
a communication link between each of the foregoing elements wherein said device is configured to:
process a document job according to one or more settings to produce output;
after processing the document job, generate on said user interface a user poll containing a plurality of setting modification choices for selection by a user;
receive via said user interface a user-selected setting modification;
determine if the modification to the settings are to be made based on the selected setting modification; and
process a subsequent document job according to the determination.

12. The document processing device as claimed in claim 11, wherein the setting modification choices include an improve quality selection, an improve speed selection, and a no change selection.

13. The document processing device as claimed in claim 11, wherein the device is further configured to generate a user poll after processing the document job by presenting a visual prompt to a user on one of the user interface of the document processing device and a display of a workstation connected to the document processing device.

14. The document processing device as claimed in claim 11, wherein the device is further configured to present an audible user prompt when generating the user poll.

15. The document processing device as claimed in claim 11, wherein the device is further configured to determine if modifications are to be made based on the selected setting modification includes selecting a mode.

16. The document processing device as claimed in claim 11, wherein the device is configured to process a subsequent document job by adjusting at least one of a speed setting and a quality setting.

17. The document processing device as claimed in claim 11, wherein the device is configured to process a subsequent document job by not adjusting the settings.

18. The document processing device as claimed in claim 17, further configured to alert the user that the one or more settings were not adjusted.

19. The document processing device as claimed in claim 11, wherein the device is configured to generate a user poll after processing the document job by presenting a stop selection to a user.

20. A computer-readable medium including instructions for modifying document processing settings in a document processing device, the instructions comprising:
processing a document job according to one or more settings to produce output;
generating a user poll having a plurality of setting modifications after processing the document job;
receiving a user-selected setting modification;
determining if the modification to the settings are to be made based on the selected setting modification; and
processing a subsequent document job according to the determination.

21. The computer-readable medium as claimed in claim 20, further comprising instructions for presenting in the user poll an improve quality selection, an improve speed selection, and a no change selection to the user.

22. The computer-readable medium as claimed in claim 21, further comprising instructions for receiving as a user-selected setting modification at least one of the improve quality selection, the improve speed selection, and the no change selection.

23. The computer-readable medium as claimed in claim 20, further comprising instructions for presenting one of a visual prompt to the user on an operator panel of the document processing device, an audible prompt to the user, and both the visual prompt and the audible prompt.

24. The computer-readable medium as claimed in claim 20, further comprising instructions for presenting on a workstation connected to a document processing device one of a visual prompt, an audible prompt, and both the visual prompt and audible prompt.

25. The computer-readable medium as claimed in claim 20, further comprising instructions for selecting a mode based on the selected setting modification.

26. The computer-readable medium as claimed in claim 20, further comprising instructions for adjusting at least one of a speed setting and a quality setting based on the selected setting modification.

27. The computer-readable medium as claimed in claim 20, further comprising instructions for not adjusting the settings based on the selected setting modification.

28. The computer-readable medium as claimed in claim 27, further comprising instructions for alerting the user that the settings were not adjusted.

29. The computer-readable medium as claimed in claim 20, further comprising instructions for presenting a stop selection.

30. A method of determining settings for a document processing device, the method comprising:
obtaining a first document job, the first document job including a first parameter;
processing the first document job according to one or more settings to produce output;
polling a user for selecting a setting modification after processing the document job;
receiving the user-selected setting modification;
storing the first parameter and the selected setting modification;
obtaining a second document job, the second document job including a second parameter; and
determining if the modification to the settings for the second document job are to be made based upon the selected setting modification.

31. The method as claimed in claim 30, wherein the first parameter and the second parameter include at least one of an application submitting the document job, a document type associated with the document job, a particular document included in the document job, a user submitting the document job, and one or more processing settings specified for the document job.

32. The method as claimed in claim 30, wherein storing the selected setting modification includes storing the one or more settings used to process the first document job and the selected setting modification.

33. The method as claimed in claim 30, further comprising determining if the modification of the settings used to process the first document job are to be made based on the selected setting modification.

34. The method as claimed in claim 33, wherein storing the selected setting modification includes storing the modified settings.

35. The method as claimed in claim 30, further comprising creating an association between the stored first parameter and the stored selected setting modification.

36. The method as claimed in claim 35, wherein determining one or more settings for the second document job includes finding one or more stored parameters similar to the second parameter and using one or more stored setting modifications associated with the one or more stored parameters.

37. The method as claimed in claim 36, further comprising combining the one or more stored setting modifications.

38. The method as claimed in claim 36, further comprising displaying the one or more stored setting modifications to a user and prompting a user to select one of the one or more stored setting modifications.

39. The method as claimed in claim 36, further comprising alerting a user when no stored parameters similar to the second parameter are found.

40. The method as claimed in claim 30, further comprising obtaining additional parameters of the second document job.

41. The method as claimed in claim 40, wherein obtaining additional parameters includes performing a pre-scan of a document.

42. The method as claimed in claim 40, wherein obtaining additional parameters includes reading a user card.

43. The method as claimed in claim 42, wherein determining one or more settings for the second document job includes reading one or more user settings from the user card.

44. The method as claimed in claim 40, wherein determining one or more settings for the second document job includes finding one or more stored parameters similar to the second parameter and the additional parameters and using one or more stored setting modifications associated with the one or more stored parameters.

45. A document processing device comprising:
a processor;
a memory;
a user interface; and
a communication link between each of the foregoing elements wherein said device is configured to:
obtain a first document job including a first parameter;
process the first document job according to one or more settings to produce output;
generate on the user interface a user poll having at least one setting modification after processing the first document;
receive a user-selected setting modification;
store the first parameter and the selected setting modification;
obtain a second document job including a second parameter, and
determine if the modification to the settings for the second document job are to be made based upon the selected setting modification.

46. The document processing device as claimed in claim 45, wherein the first parameter and the second parameter includes at least one of an application submitting the document job, a document type associated with the document job, a particular document included in the document job, a user submitting the document job, and one or more processing settings specified for the document job.

47. The document processing device as claimed in claim 45, wherein the device is configured to store the selected setting modification by storing the one or more settings used to process the first document job and the selected setting modification.

48. The document processing device as claimed in claim 45, further configured to determine if the modifications of the settings used to process the first document job are to be made based on the selected setting modification.

49. The document processing device as claimed in claim 48, wherein the device is configured to store the selected setting modification by storing the modified settings.

50. The document processing device as claimed in claim 45, further configured to create an association between the stored first parameter and the stored selected setting modification.

51. The document processing device as claimed in claim 50, wherein the device is configured to determine one or more settings for the second document job by finding one or more stored parameters similar to the second parameter and using one or more stored setting modifications associated with the one or more stored parameters.

52. The document processing device as claimed in claim 51 further configured to combine the one or more stored setting modifications.

53. The document processing device as claimed in claim 51, further configured to display the one or more stored setting modifications to a user for user selection.

54. The document processing device as claimed in claim 51, further configured to alert a user when no stored parameters similar to the second parameter are found.

55. The document processing device as claimed in claim 45, further configured to obtain additional parameters of the second document job.

56. The document processing device as claimed in claim 55, wherein the device is configured to obtain additional parameters of the second document job by performing a pre-scan of a document.

57. The document processing device as claimed in claim 55, wherein the device is configured to obtain additional parameters of the second document job by reading a user card.

58. The document processing device as claimed in claim 55, wherein the device is configured to determine one or more settings for the second document job by finding one or more stored parameters similar to the second parameter and the additional parameters and using one or more stored setting modifications associated with the one or more stored parameters.

59. The document processing device as claimed in claim 57, wherein the device is configured to determine one or more settings for the second document job by reading one or more user settings from the user card.

60. A computer-readable medium including instructions for determining document processing settings, the instructions comprising:
obtaining a first document job, the first document job including a first parameter;
processing the first document job according to one or more settings to produce output;
generating and displaying a user poll having a plurality of setting modifications after processing the first document job;
receiving a user-selected setting modification;
storing the first parameter and the setting modification;
obtaining a second document job, the second document job including a second parameter; and
determining one or more settings for the second document job based upon the selected setting modification.

61. The computer-readable medium as claimed in claim 60, wherein the first parameter and the second parameter includes at least one of an application submitting the document job, a document type associated with the document job, a particular document included in the document job, a user submitting the document job, and one or more processing settings specified for the document job.

62. The computer-readable medium as claimed in claim 60, wherein instructions for storing the selected setting modification includes instructions for storing the one or more settings used to process the first document job and the selected setting modification.

63. The computer-readable medium as claimed in claim 60, further comprising instructions for determining if modifications to the one or more settings used to process the first document job are to be made based on the setting modification.

64. The computer-readable medium as claimed in claim 63, wherein instructions for storing the selected setting modification includes storing the modified settings determined to require modification.

65. The computer-readable medium as claimed in claim 60, further comprising instructions for creating an association between the stored first parameter and the stored setting modification.

66. The computer-readable medium as claimed in claim 65, wherein instructions for determining one or more settings for the second document job include instructions for finding one or more stored parameters similar to the second parameter and using one or more stored setting modifications associated with the one or more stored parameters.

67. The computer-readable medium as claimed in claim 66, further comprising instructions for combining the one or more stored setting modifications.

68. The computer-readable medium as claimed in claim 66, further comprising instructions for displaying the one or more stored setting modifications to a user for selection and for receiving the user-selected one or more stored setting modifications.

69. The computer-readable medium as claimed in claim 66, further comprising instructions for alerting a user when no stored parameters similar to the second parameter are found.

70. The computer-readable medium as claimed in claim 60, further comprising instructions for obtaining additional parameters of the second document job.

71. The computer-readable medium as claimed in claim 70, wherein instructions for obtaining additional parameters include instructions for performing a pre-scan of a document.

72. The computer-readable medium as claimed in claim 70, wherein instructions for obtaining additional parameters include instructions for reading a user card.

73. The computer-readable medium as claimed in claim 70, wherein instructions for determining one or more settings for the second document job include instructions for finding one or more stored parameters similar to the second parameter and the additional parameters and using one or more stored setting modifications associated with the one or more stored parameters.

74. The computer-readable medium as claimed in claim 72, wherein instructions for determining one or more settings for the second document job include instructions for reading one or more user settings from the user card.

75. A system for modifying document processing settings, the system comprising:
a document processing device having a processor, a memory, and a communication link among the processor and memory wherein the processing device is configured to obtain a first document job including a first parameter, to process the first document job according to one or more settings to produce output; and
a workstation in communication with the document processing device via the communication link and configured to generate a user poll having a plurality of setting modifications after the document processing device processes the first document and to receive a user-selected setting modification.

76. The system as claimed in claim 75, wherein the workstation is further configured to transmit the selected setting modification to the document processing device.

77. The system as claimed in claim 76, wherein the document processing device is further configured to determine if modification of the one or more settings is to be made based on the selected setting modification transmitted by the workstation.

78. The system as claimed in claim 77, wherein the document processing device is further configured to process at least one subsequent document job according to the modified settings determined to require modification.

79. The system as claimed in claim 75, wherein the workstation is further configured to determine if modification to the one or more settings used by the document processing device to process the first document are to be made based on the selected setting modification and to transmit the modified settings determined to require modification to the document processing device and wherein the document processing device is further configured to process at least one subsequent document job according to such modified settings transmitted by the workstation.

80. The system as claimed in claim 75, wherein the workstation is further configured to store the first parameter and the selected setting modification.

81. The system as claimed in claim 80, wherein the workstation is further configured to create an association between the stored first parameter and the stored selected setting modification.

82. The system as claimed in claim 81, wherein the document processing device is further configured to obtain a second document job including a second parameter.

83. The system as claimed in claim 82, wherein the workstation is further configured to determine one or more settings for the second document job by finding one or more stored parameters similar to the second parameters and using one or more stored setting modifications associated with the one or more stored parameters.

84. The system as claimed in claim 83, wherein the workstation is further configured to transmit the determined one or more settings for the second document job to the document processing device and wherein the document processing device is further configured to process the second document job according to the determined one or more settings transmitted by the workstation.

85. The system as claimed in claim 80, wherein the workstation is further configured to obtain additional parameters for the second document job.

86. The system as claimed in claim 85, wherein the workstation is configured to obtain additional parameters for the second document job by reading a user card.

87. The system as claimed in claim 86, wherein the workstation is further configured to determine one or more settings for the second document job by reading one or more settings from the user card.

88. The system as claimed in claim 86, wherein the workstation is configured to determine one or more settings for the second document job by finding one or more stored parameters similar to the second parameter and the additional parameters and using one or more stored setting modifications associated with the one or more stored parameters.

89. A method of adjusting one or more settings for a document processing device, the method comprising:
processing a document job according to one or more settings to produce output; and
polling a user for a setting modification after processing the document job at a predetermined frequency.

90. The method as claimed in claim 89, further comprising changing the predetermined frequency based upon a user selection.

91. The method as claimed in claim 90, wherein changing the predetermined frequency includes presenting the user with a stop selection.

92. The method as claimed in claim 89, wherein polling a user for a setting modification after processing the document job at a predetermined frequency includes polling the user after processing every document job.

93. The method as claimed in claim 89, wherein polling a user for a setting modification after processing the document job at a predetermined frequency includes polling the user after processing the document job when one or more user selected settings for the document job are not received before processing the document job.

94. The method as claimed in claim 89, wherein polling a user for a setting modification after processing the document job at a predetermined frequency includes polling the user for a predetermined number of processed document jobs.

95. The method as claimed in claim 89, wherein polling a user for a setting modification after processing the document job at a predetermined frequency includes polling the user for a predetermined time interval.

96. The method as claimed in claim 89, wherein polling a user for a setting modification after processing the document job at a predetermined frequency includes polling the user after processing the document job when a similar document job has not previously been processed.
